(19) United States
(12) Patent Application Publication
(10) Pub. No.: US 2025/0297499 A1
(43) Pub. Date: Sep. 25, 2025

(54) KEY CYLINDER DEVICE FOR VEHICLE DOOR

(71) Applicant: Minebea AccessSolutions Inc., Miyazaki-shi (JP)

(72) Inventors: Takuya MIYAGAWA, Miyazaki (JP); Yutaro KURATOMI, Miyazaki (JP); Hikaru HIEJIMA, Miyazaki (JP)

(21) Appl. No.: 19/069,387

(22) Filed: Mar. 4, 2025

(30) Foreign Application Priority Data
Mar. 21, 2024 (JP) 2024-044978

(51) Int. Cl. E05B 79/20; E05B 83/36; E05B 85/06

(52) U.S. Cl. CPC E05B 79/20; E05B 83/36; E05B 85/06

(57) ABSTRACT

A key cylinder device includes a key cylinder turnable between an operation position at which a door lock device can be switched and a non-operation position at which the door lock device cannot be switched, a turning member turnable integrally with the key cylinder, and a pulling member configured to transmit an operating force of the key cylinder by key operation to the door lock device via the turning member. The turning member includes a winding portion around which the pulling member can be wound by the turning of the key cylinder from the non-operation position to the operation position.

### CROSS REFERENCE TO RELATED APPLICATION

This application claims benefit of priority to Japanese Patent Application 2024-044978, filed on Mar. 21, 2024, the entire content of which is incorporated herein by reference.

### BACKGROUND

### Technical Field

The present invention relates to a key cylinder device for a vehicle door.

### Background Art

A key cylinder device for switching a door lock device disposed on a door of a vehicle from a locked state to an unlocked state is known. When the door lock device is in the unlocked state, the door can be opened by operation of a handle disposed on the door. When the door lock device is in the locked state, the door cannot be opened even by operating the handle.

The key cylinder device disclosed in JP H5-25965 A includes a cable for transmitting the operating force of the key cylinder to the door lock device. One end of a wire (pulling member) provided in the cable is connected to a transmission lever provided in the key cylinder. The other end of the wire is connected to the door lock device. Thus, the transmission lever turns integrally with the key cylinder, the wire is pulled according to the turning amount of the transmission lever, and the door lock device is unlocked. As a result, the door lock device is switched from the locked state to the unlocked state.

### SUMMARY

The key cylinder device of JP H5-25965 A needs to ensure an advancing and retracting stroke of a pulling member made of a wire in order to ensure a stroke necessary for unlock operation of the door lock device. To ensure the advancing and retracting stroke of the pulling member, a distance from the rotation axis of the transmission lever to a pulling member connecting portion of the transmission lever needs to be ensured. As a result, disadvantageously, the overall length of the transmission lever lengthens, and the key cylinder device increases in size.

An object of the present invention is to suppress an increase in size of a key cylinder device for a vehicle door connected to a door lock device via a pulling member.

The present invention provides a key cylinder device for a vehicle door including: a key cylinder turnable between an operation position at which a door lock device can be switched from a locked state to an unlocked state and a non-operation position at which the door lock device cannot be switched; a turning member attached to the key cylinder and turnable integrally with the key cylinder; and a pulling member having one end connected to the turning member and configured to transmit an operating force of the key cylinder by key operation to the door lock device via the turning member. The turning member includes a winding portion around which the pulling member is windable by turning of the key cylinder from the non-operation position to the operation position.

The turning member turnable integrally with the key cylinder includes a winding portion around which the pulling member is windable by turning of the key cylinder from the non-operation position to the operation position. This can convert the turning operating force of the key cylinder by the key operation into a pulling force of the pulling member via the turning member and transmit the pulling force to the door lock device with a simple structure without increasing the number of components.

Moreover, since the pulling member is pulled by the winding to the winding portion, an advancing and retracting stroke of the pulling member can be ensured as compared with a case where the pulling member is linearly pulled by the transmission lever. Therefore, a stroke necessary for the unlock operation of the door lock device can be ensured. As compared with a case where the entire length of the transmission lever is increased, an increase in size of the key cylinder device can be suppressed, and the degree of freedom of the attachment layout to the vehicle door can be improved.

In the present invention, an increase in size of the key cylinder device for the vehicle door connected to the door lock device via the pulling member can be suppressed.

### BRIEF DESCRIPTION OF DRAWINGS

FIG. 1 is a front view of a door of a vehicle using a key cylinder device according to an embodiment of the present invention.

FIG. 2 is a block diagram illustrating a relationship among a door lock device, a handle and the key cylinder device of in FIG. 1.

FIG. 3 is a rear perspective view of the key cylinder device.

FIG. 4 is an exploded perspective view of the key cylinder device.

FIG. 5 is a cross-sectional view taken along line V-V of FIG. 3.

FIG. 6 is an exploded perspective view of a casing, a key cylinder, and a rotating member.

FIG. 7A is a perspective view illustrating a state of a cylinder unit when the key cylinder is turned to an initial position.

FIG. 7B is a perspective view illustrating a state of the cylinder unit when the key cylinder is turned to an operation position.

FIG. 8 is a cross-sectional view taken along line VIII-VIII of FIG. 3.

FIG. 9 is a perspective view illustrating a connection state of a rod to the door lock device.

### DETAILED DESCRIPTION

Hereinafter, an embodiment of the present invention will be described with reference to the drawings.

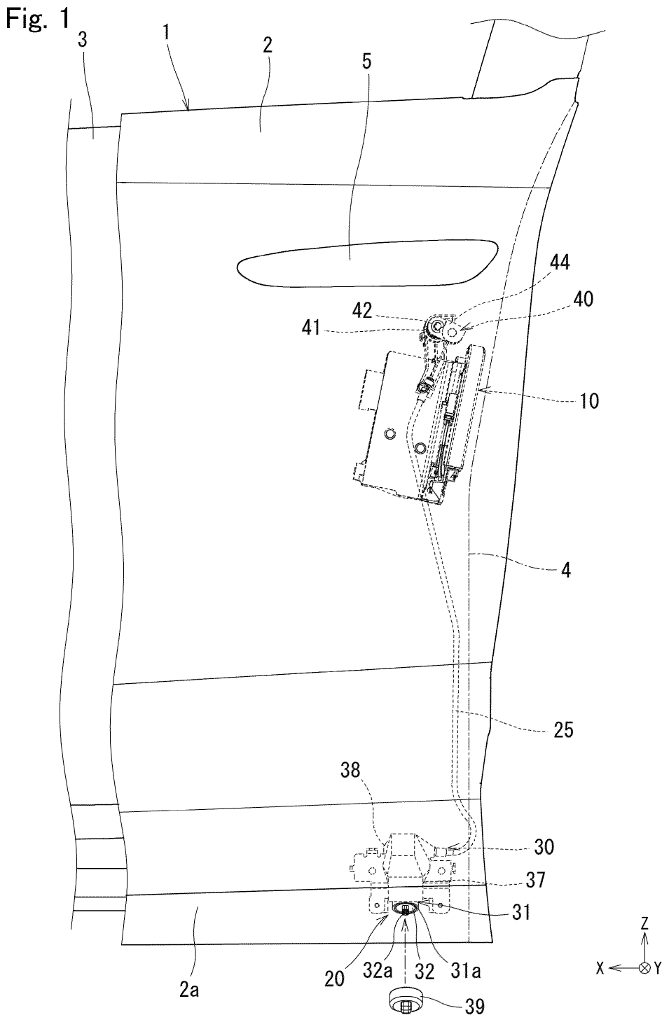

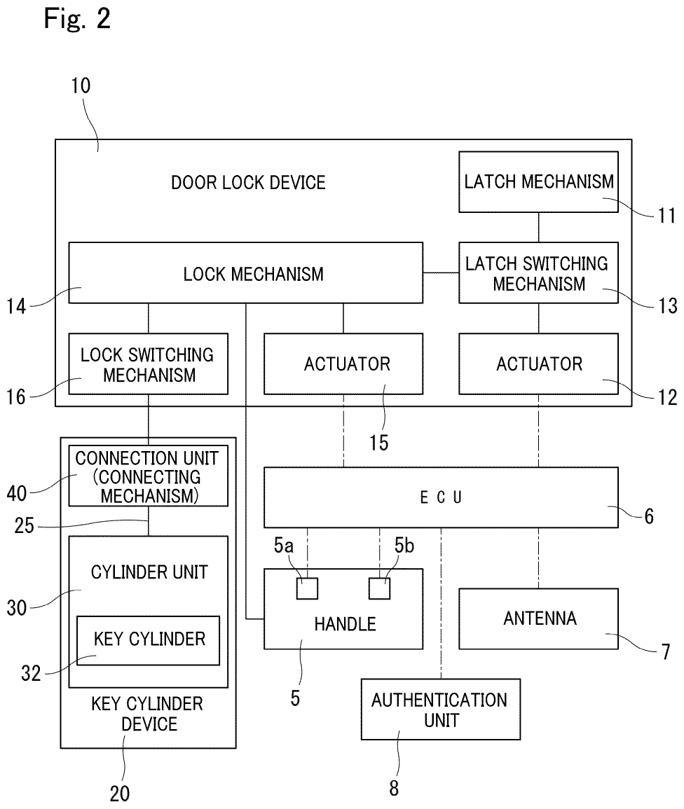

Referring to FIGS. 1 and 2, a key cylinder device 20 according to an embodiment of the present invention is attached to a door 1 of a vehicle, and switches a door lock device 10 attached to the same door 1 from a locked state to an unlocked state to allow the door 1 to be opened by an operation of a handle 5.

The key cylinder device 20 of the present embodiment is used for a left side door whose hinge shaft extends in the vehicle height direction. However, the key cylinder device 20 may be used for a right side door, a slide door, or a back door.

An X direction in the accompanying drawings is a vehicle length direction, a direction indicated by an arrow is a front side, and a direction opposite to the arrow is a rear side. A Y direction is a vehicle width direction, and a direction indicated by an arrow is an inner side (vehicle interior side), and a direction opposite to the arrow is an outer side (vehicle exterior side). A Z direction is a vehicle height direction, and a direction indicated by an arrow is an upper side, and a direction opposite to the arrow is a lower side.

Referring to FIGS. 1 and 2, the key cylinder device 20 is mechanically connected to the door lock device 10. The door lock device 10 is communicably connected to an electronic control unit (ECU) 6 mounted on the vehicle. An antenna 7 for performing wireless communication with an electronic key (not illustrated) carried by the user and an authentication unit 8 for performing key authentication are connected to the ECU 6.

The ECU 6 includes a calculation unit, a storage unit, and a communication unit (not illustrated), reads a program stored in advance in the storage unit, and executes information processing according to steps instructed by the program. When the key authentication by the authentication unit 8 is established, the ECU 6 electrically operates the door lock device 10 based on an input signal from the handle 5. On the other hand, when the key authentication by the authentication unit 8 is not established, the ECU 6 does not operate the door lock device 10 even if the signal is input from the handle 5.

Describing the outline of a door latch device 10, the door lock device 10 is disposed along an end panel 4 in a space defined by an outer panel 2, an inner panel 3, and an end panel 4 of the door 1. The door lock device 10 includes a latch mechanism 11, an actuator 12, a latch switching mechanism 13, a lock mechanism 14, an actuator 15, and a lock switching mechanism 16.

The latch mechanism 11 includes a fork and a claw and can be switched between a latched state and an unlatched state. In the latched state, the fork holds the striker of the vehicle body and holds the door 1 in the closed state. In the unlatched state, the fork releases the striker, allowing the door 1 to be opened.

The lock mechanism 14 is configured by a plurality of levers or the like and can be switched between an unlocked state and a locked state. In the unlocked state, the latch mechanism 11 can be switched from the latched state to the unlatched state via the latch switching mechanism 13. In the locked state, the latch mechanism 11 can be switched from the latched state to the unlatched state via the latch switching mechanism 13.

The latch mechanism 11 is switched from the unlatched state to the latched state by the entry of the striker into the fork when the door 1 in the open state is closed. The switching of the latch mechanism 11 from the latched state to the unlatched state from the outside of the vehicle is performed by ECU 6 electrically via the latch switching mechanism 13 in response to a signal input from a switch 5a that has detected the normal opening operation of the handle 5 in a normal state in which the actuator 12 can be operated. On the other hand, in an emergency state in which the actuator 12 cannot be operated, the switching of the latch mechanism 11 from the latched state to the unlatched state from the outside of the vehicle is manually performed via the lock mechanism 14 and the latch switching mechanism 13 by an emergency opening operation of the handle 5 by the user.

The switching (locking) of the lock mechanism 14 from the unlocked state to the locked state from the outside of the vehicle is performed by the ECU 6 electrically in response to a signal input from a switch 5b that has detected the locking operation of the handle 5 in a normal state in which the actuator 15 can be operated. The switching (unlocking) of the lock mechanism 14 from the locked state to the unlocked state from the outside of the vehicle is normally performed by the ECU 6 electrically by a signal input from the switch 5a that has detected the normal opening operation of the handle 5. On the other hand, in an emergency state in which the actuator 15 cannot be operated, the switching of the lock mechanism 14 from the locked state to the unlocked state from the outside of the vehicle is manually performed via the lock switching mechanism 16 by an emergency operation (unlock operation) of the key cylinder device 20 by the user.

As described above, the key cylinder device 20 is not used in a normal state in which the actuator 15 can be operated. Therefore, the key cylinder 32 included in the key cylinder device 20 is disposed at the lower end portion 2a of the outer panel 2 below the user's eye line so as not to impair the designability of the door 1. The lower end portion 2a is a region on the lower side of a half of the total height of the outer panel 2, and is a portion inclined to the inner side in the vehicle width direction toward the lower side.

Hereinafter, the key cylinder device 20 of the present embodiment will be specifically described.

Referring to FIGS. 1, 3, and 4, the key cylinder device 20 includes a cylinder unit (cylinder mechanism) 30, a connection unit (connection mechanism) 40, and a cable 25 that mechanically connects the cylinder unit 30 and the connection unit 40.

In the key cylinder device 20, a portion other than the distal end of the key cylinder 32 included in the cylinder unit 30 is disposed in the space between the outer panel 2 and the inner panel 3 in the door 1 and is invisible from the outside of the door 1. In the key cylinder device 20, only the distal end of the key cylinder 32 can be exposed to the outside of the vehicle. At a normal time, the distal end of the key cylinder 32 is preferably covered by the decorative member of the door 1 and exposed by the operation by the user.

### Configuration of Cable

Referring to FIGS. 1, 3, and 4, the cable 25 includes a tube 26 and a wire (pulling member) 27 each having flexibility. The wire 27 is a transmission member for transmitting the operating force of the key cylinder 32 to the door lock device 10 via the connection unit 40. The wire 27 is movably inserted into the tube 26, and can advance/retract in conjunction with the turning of the key cylinder 32. A circular column shaped wire end 28 is fixed to each end of the wire 27. Of the pair of wire ends 28, one located at the lower end is connected to the cylinder unit 30, and the other located at the upper end is connected to the connection unit 40.

### Configuration of Cylinder Unit

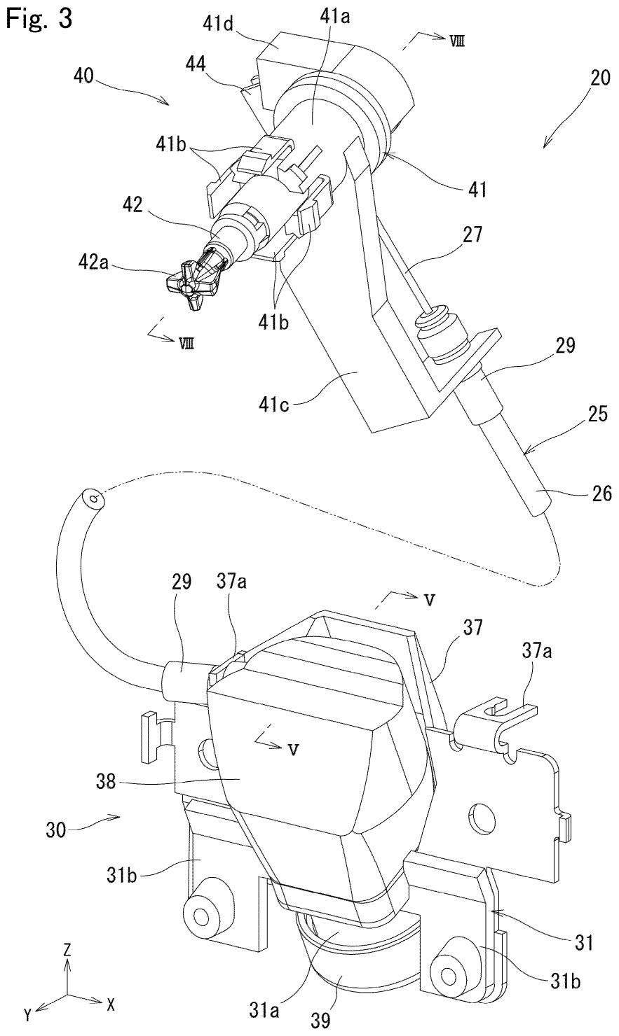

Referring to FIGS. 3 to 5, the cylinder unit 30 is a configuration for unlocking the door lock device 10 from the outside of the door 1 illustrated in FIG. 1. The cylinder unit 30 includes a casing 31, a key cylinder 32, a turning member 35, an anti-theft cover 37, a waterproof cover 38, and a waterproof cap 39.

The casing 31 is a configuration for attaching the cylinder unit 30 to the outer panel 2 illustrated in FIG. 1. The casing 31 includes a body portion 31a and an attachment portion 31b. The body portion 31a has a cylindrical shape and turnably supports the key cylinder 32 therein. An axis line A of the body portion 31a is inclined to the outer side in the vehicle width direction toward the lower side, but extends in the vehicle height direction as a whole. The attachment portion 31b is a configuration for attaching to the outer panel 2 illustrated in FIG. 1, and protrudes toward both sides in the vehicle length direction from the body portion 31a.

The key cylinder 32 includes a key hole 32a into which a regular mechanical key (not illustrated) can be inserted. The key cylinder 32 is attached to the body portion 31a of the casing 31 and is disposed at the lower end portion 2a of the outer panel 2 illustrated in FIG. 1 with the key hole 32a directed to the lower side (road surface). The rotation axis of the key cylinder 32 coincides with the axis line A of the body portion 31a by the attachment of the key cylinder 32 to the casing 31. In the following description, the axis line A of the body portion 31a may be referred to as a rotation axis A of the key cylinder 32.

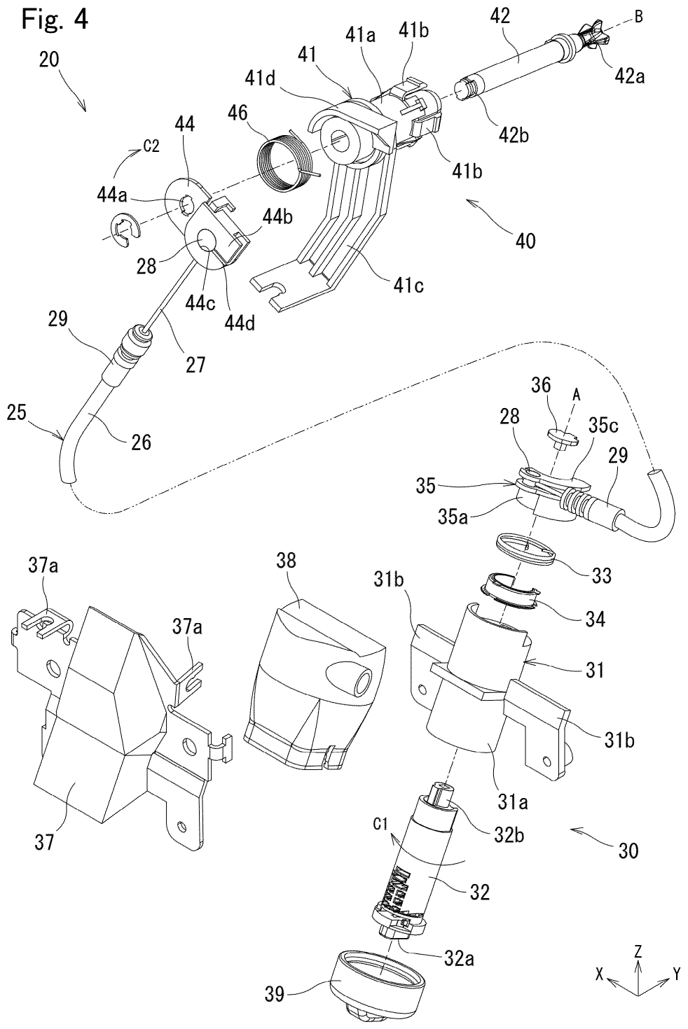

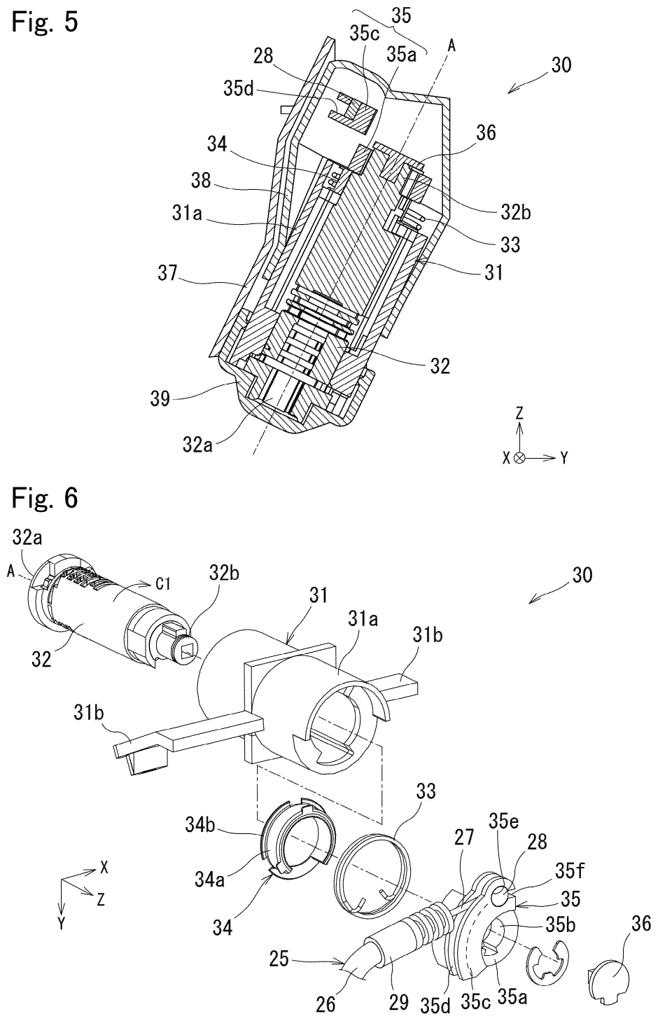

The key cylinder 32 is turnable between an initial position (non-operation position) illustrated in FIGS. 1 and 5 and an unlocking position (operation position) turned from the initial position by an angle defined in a direction C1 (counterclockwise in FIG. 1) illustrated in FIG. 4 by an operation of the mechanical key. When the key cylinder 32 is turned to the initial position, the lock mechanism 14 illustrated in FIG. 2 cannot be switched. When the key cylinder 32 is turned from the initial position to the unlocking position, the lock mechanism 14 is switched from the locked state to the unlocked state via the lock switching mechanism 16 illustrated in FIG. 2. Note that the transmission of the operating force of the key cylinder 32 to the lock mechanism 14 illustrated in FIG. 2 will be described in detail later.

Referring to FIGS. 4 to 6, the key cylinder 32 is biased from the unlocking position to the initial position by a spring (first biasing member) 33. The spring 33 is attached to the holding member 34 and is disposed inside the body portion 31a of the casing 31 together with the holding member 34.

The holding member 34 includes a holding portion 34a having a C shape when viewed from the direction in which the rotation axis A extends, and an annular flange portion 34b provided at one end of the holding portion 34a. The holding member 34 is disposed so as to surround the key cylinder 32. The flange portion 34b includes a positioning notch, and is attached to the body portion 31a so as not to be relatively movable in both the direction in which the rotation axis A extends and the circumferential direction around the rotation axis A.

Both ends of the spring 33 are locked with the key cylinder 32 and the holding portion 34a, respectively. When the key cylinder 32 is turned around the rotation axis A with respect to the holding portion 34a by key operation, the spring 33 is compressed. When the key operation is stopped, the key cylinder 32 turns to the initial position with respect to the holding portion 34a by the biasing force of the spring 33.

The turning member 35 has a configuration of being turned integrally with the key cylinder 32, and pulling the wire 27 so as to wind the wire 27 at the time of unlock operation to convert a turning operating force of the key cylinder 32 into a pulling force of the wire 27 and transmitting the pulling force to the lock switching mechanism 16 illustrated in FIG. 2. The turning member 35 includes a base portion 35a and a winding portion 35c provided integrally with the base portion 35a.

The base portion 35a has a cylindrical shape having the rotation axis A as the center, and is attached to the upper end portion 32b of the key cylinder 32 so as not to be relatively movable in both the direction in which the rotation axis A extends and the circumferential direction around the rotation axis A. Specifically, an attachment hole 35b having an engagement groove is provided at the center of the base portion 35a, and an engagement protrusion is provided at the upper end portion 32b of the key cylinder 32. The turning member 35 is attached to the key cylinder 32 so as not to be relatively turnable by the engagement of the engagement protrusion and the engagement groove. A C-shaped washer and a stopper member 36 prevent the base portion 35a from falling off from the key cylinder 32.

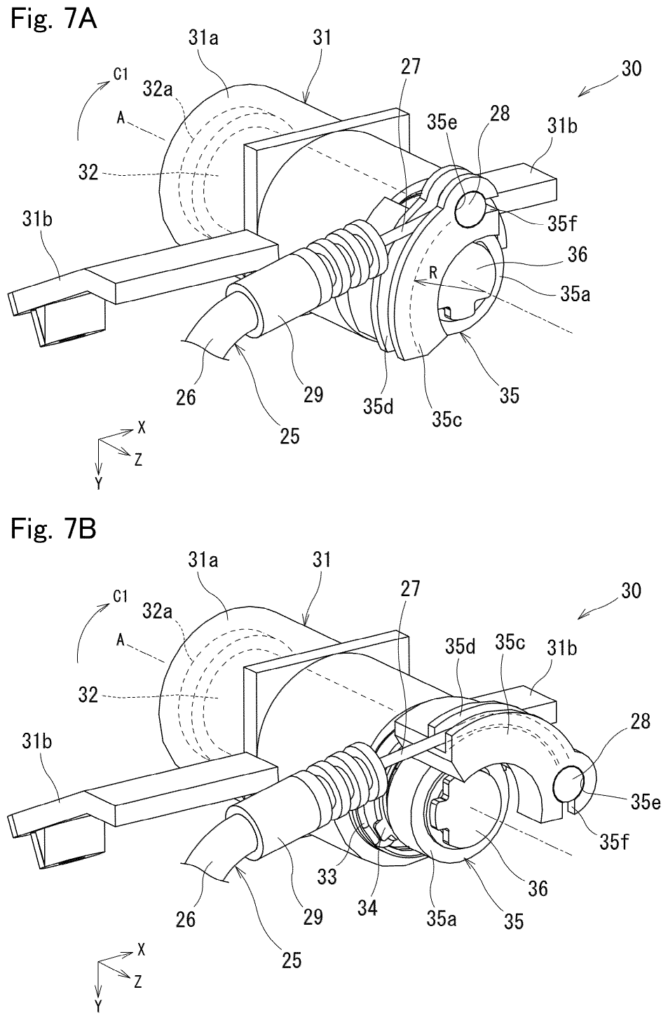

The winding portion 35c is a configuration for winding the wire 27 by the turning of the key cylinder 32 from the initial position illustrated in FIG. 7A to the unlocking position illustrated in FIG. 7B. The winding portion 35c has a fan shape concentric with the base portion 35a, and protrudes to the radially outer side from the base portion 35a. The angle between a pair of radially extending side edges of the winding portion 35c is the turning angle or more of the key cylinder 32 from the initial position illustrated in FIG. 7A to the unlocking position illustrated in FIG. 7B.

The winding portion 35c includes a concave groove 35d that is recessed from the outer side to the inner side in the radial direction, extends in the circumferential direction around the rotation axis A, and is formed in an arc shape. A connection hole 35e for turnably connecting the wire end 28 and an insertion groove 35f for inserting the wire 27 are provided at a distal end of the winding portion 35c in the direction C1 in which the key cylinder 32 is rotated. The groove bottom of the concave groove 35d is formed with a radius R passing through the center of the connection hole 35e.

Referring to FIGS. 7A and 7B, the turning member 35 integrally turns in the direction C1 by the turning of the key cylinder 32 in the direction C1. This causes the wire 27 to be pulled toward the same direction C1 and wound around the groove bottom of the concave groove 35d in an arc shape. Here, in the case of the known transmission lever, the wire 27 is linearly pulled between the tube end 29 attached to the end of the tube 26 and the wire end 28. Thus, when the radius R from the rotation axis A to the connection hole 35e of the wire end 28 is the same, the pulling amount of the wire 27 can be increased than in the known transmission lever in the turning member 35 of the present embodiment. Therefore, the advancing and retracting stroke of the wire 27 can be ensured. On the other hand, when the advancing and retracting stroke of the wire 27 by the known transmission lever is the same as the advancing and retracting stroke of the wire 27 by the turning member 35 of the present embodiment, the size can be reduced with the turning member 35 of the present embodiment.

Referring to FIGS. 3 to 5, the anti-theft cover 37 is a configuration for inhibiting unauthorized operation of the turning member 35 and the wire 27 by a third party. The anti-theft cover 37 is attached to the outer side in the vehicle width direction of the casing 31, and covers the casing 31 including the key cylinder 32, the turning member 35, and the lower end of the wire 27. This suppresses the turning member 35 and the wire 27 from being directly operated by a member intended picking. The anti-theft cover 37 is provided with a holding portion 37a that positions and holds the tube end 29.

The waterproof cover 38 is provided to prevent water from entering the casing 31. The waterproof cover 38 covers the body portion 31a of the casing 31 including the key cylinder 32, the turning member 35, and the lower end of the wire 27. This prevents water entering the door 1 from between the outer panel 2 and the inner panel 3 from adhering to the turning member 35 and the lower end of the wire 27.

The waterproof cap 39 is a configuration for preventing water from entering the key cylinder 32 through the key hole 32a. The waterproof cap 39 is a cylindrical body with one end opened and the other end closed, and is detachably attached to the outer end portion of the body portion 31a of the casing 31 including the key cylinder 32.

### Configuration of Connection Unit

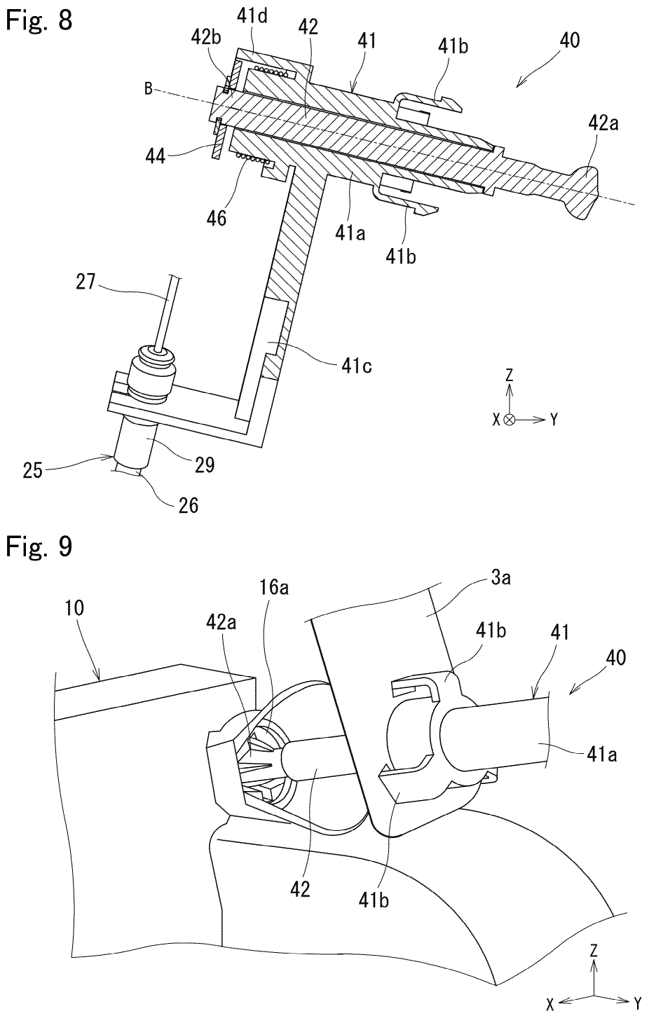

Referring to FIGS. 3, 4, and 8, the connection unit 40 is a configuration for connecting the cylinder unit 30 to the door lock device 10 by way of the wire 27. In the door 1 illustrated in FIG. 1, the connection unit 40 is disposed above the cylinder unit 30 with an interval, and is attached at a height position equivalent to that of the door lock device 10. The connection unit 40 includes a support member 41, a rod (connecting member) 42, and a connection lever 44.

The support member 41 is a configuration for turnably supporting the rod 42, and attaching the connection lever 44 including the rod 42 to the attachment panel 3a (see FIG. 9) joined to the inner panel 3 illustrated in FIG. 1. The support member 41 includes a body portion 41a, an attachment piece 41b, and a holding portion 41c.

The body portion 41a has a cylindrical shape and turnably supports the rod 42 therein. The axis line B of the body portion 41a is inclined downward to the inner side in the vehicle width direction, but extends in the vehicle width direction as a whole. A cover portion 41d is provided at an end portion on the outer side in the vehicle width direction of the body portion 41a. The attachment piece 41b is a configuration for attaching to the attachment panel 3a illustrated in FIG. 9, and a plurality of attachment pieces 41b are provided at an end portion on the inner side in the vehicle width direction of the body portion 41a at intervals in the circumferential direction. The holding portion 41c is a configuration for positioning and holding the tube end 29, and protrudes to the lower side from the body portion 41a toward the connection unit 40.

Referring to FIGS. 3, 4, and 9, the rod 42 is a configuration for connecting to a connection receiving portion 16a similar to the known connection receiving portion provided in the door lock device 10. The rod 42 has a rod shape, and is attached to the body portion 41a of the support member 41 so as to be allowed to turn about the axis line B. The axis line of the rod 42 coincides with the axis line B of the body portion 41a due to the attachment to the support member 41. The entire length of the rod 42 is longer than the entire length of the body portion 41a. Both ends of the rod 42 protrude from both ends of the body portion 41a.

A connecting portion 42a is provided at an end portion on the inner side in the vehicle width direction of the rod 42. The connecting portion 42a can be connected to the connection receiving portion 16a of the lock switching mechanism 16 illustrated in FIG. 2. The connecting portion 42a includes a plurality of projecting pieces radially projecting outward from the rod 42 in the radial direction, and can transmit the turning force of the rod 42 to the lock switching mechanism 16. Referring to FIGS. 3, 4, and 8, an attachment portion 42b to which the connection lever 44 is attached is provided at an end portion on the outer side in the vehicle width direction of the rod 42.

The connection lever 44 is a conversion member for converting the movement of the wire 27 in the advancing/retracting direction into the turning of the rod 42. The connection lever 44 is provided with an attachment hole 44a into which the attachment portion 42b can be inserted. The turning of the lever 44 with respect to the attachment portion 42b is restricted by engagement between an engagement groove provided in the attachment hole 44a and an engagement protrusion provided on the rod 42. Thus, the connection lever 44 is turnable integrally with the rod 42.

The connection lever 44 includes a connecting portion 44b for connecting the wire 27. The connecting portion 44b projects to the radially outer side of the rod 42, which is a direction orthogonal to the axis line B. The connecting portion 44b of the present embodiment is constituted by a pair of plate portions located at intervals in the direction in which the axis line B extends. The connecting portion 44b is provided with a connection hole 44c to which the wire end 28 is turnably connected and an insertion groove 44d for inserting the wire 27.

The connection lever 44 configured as described above is turnable between the initial position illustrated in FIGS. 3 and 4 and the operating position turned by an angle defined in a direction C2 (clockwise in FIG. 4) by the unlock operation of the lock mechanism 14 illustrated in FIG. 2.

A spring (second biasing member) 46 that biases the connection lever 44 from the operating position to the initial position is disposed between the connection lever 44 and the support member 41. The spring 46 is disposed at an end portion on the outer side in the vehicle width direction of the body portion 41a of the support member 41 and is covered by the cover portion 41d. One end of the spring 46 is locked with the cover portion 41d, and the other end of the spring 46 is locked with the connection lever 44.

Next, the operation of the key cylinder device 20 will be described.

When the key cylinder 32 is turned in the direction C1 by the key operation, the turning member 35 integrally turns in the direction C1 (see FIGS. 7A and 7B). This causes the wire 27 to be pulled downward (first direction) by the turning of the turning member 35. As a result, the connection lever 44 turns in the direction C2, and the rod 42 rotates integrally with the connection lever 44 in the direction C2. In this manner, the operating force of the key cylinder 32 is transmitted to the lock switching mechanism 16 illustrated in FIG. 2, whereby the lock mechanism 14 is switched from the locked state to the unlocked state. At this time, in the present embodiment, the advancing and retracting stroke of the wire 27 can be ensured by the turning member 35, allowing the stroke necessary for the unlock operation of the lock mechanism 14 to be sufficiently ensured.

When the key operation is stopped, the key cylinder 32 turns from the unlocking position to the initial position by the biasing force of the spring 33. The rod 42 and the connection lever 44 turn from the operating position to the initial position by the biasing force of the spring 46. As a result, the wire 27 is pulled upward (second direction) by the biasing force of the springs 33 and 46.

Here, since both the movement of the wire 27 to the initial position and the turning of the connection lever 44 are upward, a force for moving against gravity is required. The entire length of the cable 25 is long, and the cable 25 may be curved and routed in consideration of other members. As a result, the resistance between the tube 26 and the wire 27 increases, and thus a situation in which the key cylinder 32, the turning member 35, the wire 27, and the connection lever 44 cannot be returned to the initial positions only by the biasing force of the spring 33 disposed in the key cylinder 32 may occur.

On the other hand, in the key cylinder device 20 of the present embodiment, the connection unit 40 is arranged above the key cylinder 32 at an interval, but the cylinder unit 30 includes the spring 33 that returns the key cylinder 32 to the initial position, and the connection unit 40 includes the spring 46 that returns the connection lever 44 to the initial position. Thus, the wire 27 and the connection lever 44 can be moved upward against the resistance between the tube 26 and the wire 27 and gravity. Therefore, the key cylinder 32, the turning member 35, the wire 27, and the connection lever 44 can be reliably returned to the initial positions.

The key cylinder device 20 configured as described above has the following features.

The turning member 35 that can turn integrally with the key cylinder 32 includes a winding portion 35c around which the wire 27 can be wound by the turning of the key cylinder 32 from the initial position to the unlocking position. Thus, the turning operating force of the key cylinder 32 by the key operation can be converted into a pulling force of the wire 27 via the turning member 35 and transmitted to the door lock device 10 with a simple structure without increasing the number of components.

In addition, since the wire 27 is wound around the winding portion 35c, the advancing and retracting stroke of the wire 27 can be ensured as compared with a case where the wire 27 is linearly pulled by the transmission lever. Therefore, a stroke necessary for the unlock operation of the door lock device 10 can be ensured. As compared with a case where the entire length of the transmission lever is increased, an increase in size of the key cylinder device 20 can be suppressed, and the degree of freedom of the attachment layout to the door 1 of the vehicle can be improved.

The winding portion 35c includes a concave groove 35d formed in an arc shape. This can ensure a stroke necessary for the unlock operation of the door lock device 10 with the smallest possible turning amount of the turning member 35. Therefore, an increase in size of the key cylinder device 20 can be effectively suppressed. Moreover, in a winding state of the wire 27 on the winding portion 35c, the wire 27 is in line contact with the winding portion 35c, allowing the load acting on the wire 27 by pulling to be evenly distributed to the portion of the wire 27 wound around the winding portion 35c. Therefore, a load on a local portion of the wire 27 can be prevented, thereby reducing breakage of the wire 27.

The winding portion 35c extends in the circumferential direction around the rotation axis A of the key cylinder 32. This can improve the transmission efficiency of the operating force of the key cylinder 32 to the door lock device 10 disposed away from the key cylinder 32.

The key cylinder 32 is disposed at the lower end portion of the door 1 of the vehicle. This causes the key cylinder 32 to be located below the user's eye line and makes it difficult to visually recognize, allowing the designability of the door 1 of the vehicle to be improved.

The key cylinder 32 is disposed so that the key hole 32a is directed toward the lower side. This can reliably dispose the key cylinder 32 in the door 1 having a limited dimension in the thickness direction.

Then anti-theft cover 37 for covering the key cylinder 32 and suppressing the operation from the outside by a member intended for picking is provided. This can ensure the anti-theft property and thus suppress the door lock device 10 from being switched from the locked state to the unlocked state by unauthorized operation of the turning member 35 and the wire 27.

The waterproof cover 38 configured to cover the key cylinder 32 and prevent entering of water is provided. This can ensure the waterproof property and thus suppress the operation failure of the key cylinder 32, the turning member 35, and the wire 27.

Note that the present invention is not limited to the configuration of the above-described embodiment, and various modifications can be made.

For example, the rotation axis of the winding portion 35c including the concave groove 35d may be located at an interval with respect to the rotation axis A of the key cylinder 32, and the winding portion 35c may not have an arc shape in a geometrically strict sense as long as it is configured to extend in the circumferential direction around the rotation axis A.

The cylinder unit 30 may be disposed on the upper side of the connection unit 40, or may be disposed spaced apart in the vehicle length direction at the same height position as the connection unit 40. The key cylinder 32 may be disposed so as to be directed to the outer side in the vehicle width direction. The key cylinder 32 may have a configuration of switching the door lock device 10 from the unlocked state to the locked state by turning from the initial position (non-operation position) to the locked position (operation position).

The key cylinder device 20 may have a configuration in which the upper end of the wire 27 is directly connected to the lock switching mechanism 16 of the door lock device 10 without including the connection unit 40.

What is claimed is:

1. A key cylinder device for a vehicle door, the key cylinder device comprising:
a key cylinder turnable between an operation position at which a door lock device can be switched to a locked state or an unlocked state and a non-operation position at which the door lock device cannot be switched;
a turning member attached to the key cylinder and turnable integrally with the key cylinder; and
a pulling member having one end connected to the turning member and configured to transmit an operating force of the key cylinder by key operation to the door lock device via the turning member; wherein
the turning member includes a winding portion around which the pulling member is windable by turning of the key cylinder from the non-operation position to the operation position.

2. The key cylinder device for a vehicle door according to claim 1, wherein the winding portion includes a concave groove formed in an arc shape.

3. The key cylinder device for a vehicle door according to claim 1, wherein the winding portion extends in a circumferential direction around a rotation axis of the key cylinder.

4. The key cylinder device for a vehicle door according to claim 1, wherein the key cylinder is disposed at a lower end portion of the vehicle door.

5. The key cylinder device for a vehicle door according to claim 1, wherein the key cylinder is disposed such that a key hole is directed to a lower side.

6. The key cylinder device for a vehicle door according to claim 1, comprising a cover configured to cover at least the key cylinder and suppress operation from outside.

7. The key cylinder device for a vehicle door according to claim 1, comprising a cover configured to cover at least the key cylinder and prevent entering of water.

8. The key cylinder device for a vehicle door according to claim 2, wherein the winding portion extends in a circumferential direction around a rotation axis of the key cylinder.

9. The key cylinder device for a vehicle door according to claim 2, wherein the key cylinder is disposed at a lower end portion of the vehicle door.

10. The key cylinder device for a vehicle door according to claim 2, wherein the key cylinder is disposed such that a key hole is directed to a lower side.

11. The key cylinder device for a vehicle door according to claim 3, wherein the key cylinder is disposed such that a key hole is directed to a lower side.

12. The key cylinder device for a vehicle door according to claim 2, comprising a cover configured to cover at least the key cylinder and suppress operation from outside.

13. The key cylinder device for a vehicle door according to claim 2, comprising a cover configured to cover at least the key cylinder and prevent entering of water.
